(19) United States
(12) Patent Application Publication
(10) Pub. No.: US 2025/0232368 A1
(43) Pub. Date: Jul. 17, 2025

(54) METHOD AND SYSTEM TO FUND HOME IMPROVEMENT PROJECT OF A CONSUMER

(71) Applicant: 1ANDFUND, LLC, Appleton, WI (US)

(72) Inventors: Robert L. Macklin, Appleton, WI (US); Justin A. Hatcher, Oshkosh, WI (US); Jennifer L. Lau-Hatcher, Oshkosh, WI (US); Christopher R. Bower, Oshkosh, WI (US); Evan D. Dodge, Montrose, CO (US); Skyler R. Severns, Combined Locks, WI (US); Joseph F. Moran, Appleton, WI (US)

(73) Assignee: 1ANDFUND, LLC, Appleton, WI (US)

(21) Appl. No.: 19/024,913

(22) Filed: Jan. 16, 2025

Related U.S. Application Data
(60) Provisional application No. 63/621,738, filed on Jan. 17, 2024.

(51) Int. Cl. G06Q 40/03

(52) U.S. Cl. CPC G06Q 40/03

(57) ABSTRACT

Methods and systems for achieving funding for home improvement projects for consumers are disclosed herein. In one example embodiment, a method includes providing a first computer (101) operated by a transaction facilitation company and configured to communicate with one or more other computers by at least one communication link. The method also includes receiving first information concerning a lead relating to the project, receiving second information relating to a soft credit application, and sending third information relating to a soft credit pull report. The method further includes receiving fourth information that includes an indication that a lending company has approved of the credit application, and additionally sending, for receipt either by a third computer (103) or a fourth computer (104), the fourth information or further information based thereon. Based upon the fourth or further information, the consumer is able to complete a loan arrangement to fund the project.

### CROSS-REFERENCE TO RELATED APPLICATIONS

The present application claims priority to U.S. provisional patent application No. 63/621,738 filed on Jan. 17, 2024 and entitled “Method and System to Fund Home Improvement Project of a Consumer”, the contents of which are incorporated by reference herein.

### FIELD

The present disclosure relates to methods and systems for consumer lending and, more particularly, relates to methods and systems for facilitating consumer lending in regard to consumer home improvement projects by matching borrowers with potential lenders.

### BACKGROUND

Consumer lending (or consumer credit) is an important or critical process of financing that allows for consumers to make a variety of purchases of goods or services. There are various manners in which consumer lending occurs depending upon a variety of factors including, for example, the types of goods or services that are being provided or the costs of such goods or services. For example, some consumer lending is achieved through the use of credit cards and associated credit card transactions.

When the costs of goods or services being purchased become higher, consumer lending transactions can become more complicated and the options available to consumers can become more limited. In the context of home improvement projects, for example, which can involve costly remodeling expenses or include the implementation of costly fixtures or appliances, consumers often work with third party contractors. To the extent consumer lending is available at all to a consumer (as a borrower) in such a context, the consumer often will be limited to pursuing consumer lending from a specific lender with which a particular third party contractor has a special relationship (e.g., which is offered as a single embedded finance choice) when selling a home improvement project, and the consumer will need to satisfy the requirements of that specific lender in order to achieve the desired financing. Such requirements may be excessively onerous to the consumer, or the consumer may be incapable of satisfying the requirements. In such circumstances the consumer may not be able to move forward with the desired home improvement project, or may not be able to have a particularly desired third party contractor move forward with the desired home improvement project.

Further, even to the extent that a consumer is not limited to pursuing consumer lending from a specific lender, applying to multiple lenders may also be onerous and time-consuming for a consumer or for a third party contractor working with the consumer. For example, in such circumstance, the consumer may need to complete a different (and potentially complicated) loan application form for each different lender with respect to which the consumer is applying for financing. Further, even when applications to multiple lenders are pursued, such efforts still may not result in desired funding for the home improvement project that is well-suited for the consumer.

For at least one or more of these reasons, or one or more other reasons, it would be advantageous if new or improved systems and methods for conducting or facilitating consumer lending in regard to home improvement projects could be developed.

### SUMMARY

The present disclosure is intended to encompass a variety of embodiments of systems and methods that relate to or facilitate the consumer lending in relation to home improvement projects.

In at least some example embodiments, the present disclosure relates to a method for achieving funding for a first home improvement project of interest to a first consumer. The method includes providing at least one first computer including at least one processing device and at least one memory device, wherein the at least one first computer is operated by a transaction facilitation company and is configured to communicate with one or more other computers by at least one internet-based communication link. The method additionally includes receiving first information at the at least one first computer from the at least one internet-based communication link, the first information concerning at least one lead relating to the first home improvement project of interest to the first consumer. Further, the method also includes additionally receiving second information at the at least one first computer from the at least one internet-based communication link, the second information relating to a first soft credit application by the first consumer, and sending third information for receipt by one or more lending company computers including a second computer operated by a first lending company, the third information relating to a soft credit pull report. Additionally, the method includes further receiving fourth information at the at least one first computer from the at least one internet-based communication link at least indirectly from the one or more lending company computers including the second computer, where the fourth information includes an indication that the first lending company has approved of the first soft credit application. Further, the method includes additionally sending, for receipt either by a third computer operated by a first contractor or a fourth computer operated by the first consumer, the fourth information or further information based upon the fourth information. Based upon the fourth information or the further information, the first consumer is able at least indirectly to complete a loan arrangement so as to fund the first home improvement project.

Additionally, in at least some example embodiments, the present disclosure relates to a system for achieving funding for a first home improvement project of interest to a first consumer. The system includes at least one first computer including at least one processing device and at least one memory device, where the at least one first computer is operated by a transaction facilitation company. The at least one first computer is configured to engage in internet-based communications by at least one internet-based communication link with a plurality of other computers, the plurality of other computers including each of (a) one or more second computers respectively operated or controlled by one or more lending companies including a first lending company, respectively, (b) one or more third computers respectively operated or controlled by one or more contractors, respectively, (c) one or more fourth computers respectively operated or controlled by one or more consumers including the first consumer, respectively, (d) one or more fifth computers respectively operated or controlled by one or more lead generators, respectively, and (e) one or more sixth computers respectively operated or controlled by one or more credit reporting agencies, respectively. Additionally, the at least one first computer is programmed to operate in accordance with software so that the at least one first computer is configured to: receive first information concerning at least one lead relating to the first home improvement project of interest to the first consumer; additionally receive second information relating to a first soft credit application by the first consumer; based upon a soft credit pull report, send third information for receipt by the one or more second computers; further receive fourth information at least indirectly from the one or more second computers, the fourth information includes an indication that the first lending company has approved of the first soft credit application; and additionally send, for receipt either by the one or more third computers or the one or more fourth computers, the fourth information or further information based upon the fourth information, so as to enable the first consumer is able at least indirectly to complete a loan arrangement so as to fund the first home improvement project.

Notwithstanding the above examples, the present invention is intended to encompass a variety of other embodiments including for example other embodiments as are described in further detail below as well as other embodiments that are within the scope of the claims set forth herein.

### BRIEF DESCRIPTION OF THE DRAWINGS

Embodiments of the disclosure are disclosed with reference to the accompanying drawings and are for illustrative purposes only. The disclosure is not limited in its application to the details of assembly or arrangements of components, or orderings of process steps, illustrated in the drawings. The disclosure is capable of other embodiments or of being practiced or carried out in other various manners. In the drawings:

FIG. 1 is a block diagram showing a system for facilitating consumer lending in regard to home improvement projects in accordance with an example embodiment encompassed herein;

FIG. 2 is a block diagram showing, in schematic form, a computer as can be implemented in the system of FIG. 1;

FIG. 3 is a flow chart (or financing process chart) showing example steps of a first example method for achieving funding for a home improvement project, as can be performed by the system of FIG. 1;

FIG. 4 is a flow chart (or web lead process chart) that shows example steps of a second example method for generating and utilizing a web lead for a home improvement project, as can be performed by the system of FIG. 1;

FIG. 5 is a flow chart (or phone lead process chart) that shows example steps of a third example method for generating and utilizing a phone lead for a home improvement project, as can be performed by the system of FIG. 1;

FIG. 6 is a block diagram showing schematically a server computer having a large-scale least recently used (LRU) cache and an appetite engine, as can be implemented in any of the transaction facilitator computer(s) of the system of FIG. 1 in at least some embodiments;

FIG. 7 is a flow chart that shows example steps of a fourth example method to achieve, or facilitate the achieving of, funding for home improvement projects, particularly when the system includes the server computer shown in FIG. 6; and

FIG. 8 is a flow chart that shows example steps of a fifth example method to achieve, or facilitate the achieving of, funding for home improvement projects, particularly when the system includes the server computer shown in FIG. 6, and particularly relating to how the appetite engine evaluates and calculates application scores.

The drawings show some but not all embodiments. The elements depicted in the drawings are illustrative and not necessarily to scale, and the same (or similar) reference numbers denote the same (or similar) features throughout the drawings, though all the same (or similar) features are not always separately numbered to help avoid over numbering and obscuring what the drawings are disclosing.

### DETAILED DESCRIPTION

The present inventors have recognized that there exists a need for an improved system and/or method for facilitating the consumer lending process in regard to home improvement projects of consumers. The present inventors have more particularly recognized that this need exists particularly in the context when consumers are working with third party contractors (or sales designers or representatives). Indeed, in many cases, it is important that such third party contractors be able to facilitate the financing process and help consumers attain the funding they desire or require in order to proceed with such home improvement projects.

In view of such recognized needs, and to address one or more deficiencies associated with conventional systems and methods, the present disclosure in at least some example embodiments relates to an improved system and/or method for facilitating consumer lending in regard to home improvement projects that operates to enable the meeting of desirable requirements for connecting up qualified consumers with willing lenders. Also, in at least some embodiments, the present disclosure relates to an improved system and/or method that operates to identify funding options available to a consumer seeking to complete a home improvement project with a contractor, based upon one or more factors including, for example, the contractor's lender network, the consumer's creditworthiness, and the lender's credit. Further, in at least some embodiments encompassed herein, the present disclosure relates to an improved system and/or method for facilitating the consumer lending process in regard to home improvement projects that includes a financial consulting and lead generation method and system that focuses on the home improvement space. The improved system and/or method works with contractors to find lenders that offer lending programs that work for the contractor's sales process, as desired by a consumer.

As already discussed above, in conventional methods of consumer lending in the context of home improvement projects, contractors often offer only a single embedded finance choice when selling a home improvement project, and if more than one financing choice from more than one lender is available, a consumer must complete a new loan application for each lender. In contrast, the present disclosure in at least some embodiments endeavors to make available a number of lenders (typically more than one lender, and possibly many more than one lender) to each contractor, to help the contractor identify a variety of lenders for the contractors and/or consumers to choose from. Further, in this manner, there can be a better fit between consumer financing wants and lending company desires for each qualified consumer. Indeed, in at least some embodiments, the improved system and/or method encompassed herein makes it possible to get to this better fit more quickly and efficiently than is possible with conventional methods, insofar as the improved system and/or method operates to direct the right (or most appropriate) financing application to the right lender for a quicker review and decision by all involved.

In at least some further embodiments encompassed by the present disclosure, an improved system and/or method also involves or works with lead generators to provide contractors leads containing basic information about the ability of the consumer to obtain financing as well. Such an improved system and/or method thus contemplates working with third parties that produce leads to provide to contractors. These leads can be passed to contractors through a web-based lead portal, or via transfers of phone calls. During the lead process the consumer would generally be asked to check a box on a web form to consent to have their information transferred to a contractor, and simultaneously to approve a soft credit pull. Although the nature of a soft credit pull on behalf of a consumer (or applicant) can vary depending upon the embodiment, in at least some embodiments a soft credit pull can be a credit inquiry (e.g., to a credit reporting agency) that is submitted in a manner such that the credit inquiry (a) does not affect the consumer's credit score, (b) will not be visible to creditors, (c) will not impact the consumer's creditworthiness, and/or (d) can be requested and performed without needing to provide one or more pieces of personal or sensitive information about the consumer that might typically be required when pursuing a standard credit report (e.g., without needing to provide the consumer's social security number).

In at least some additional embodiments, the present disclosure relates to an improved system and/or method that is configured to facilitate or enhance, or that employs particular features to facilitate or enhance, the communication process. For example, in an example embodiment, when there is a phone transfer, the contractor's lead setter would read the consent language for a soft credit pull, and then when consent granted, notify a contractor via a leads CRM (e.g., a customer relations management application), for example such as with a script as described below. Alternatively or additionally, once a contractor or home improvement sales representative has set an appointment and has made a sale, the consumer would be asked to submit a credit application. As part of that, the consumer would be asked to consent to a soft, and if approved, hard credit pull. The soft credit pull would then help determine which single lender gets the consumer's application, based on, for example: the likelihood of approval, types of financing the contractor wants to offer, and the loan programs the customer is interested in. If that lender declines, the credit application would be presented to another lender, and so on. If no lenders are found, the contractor and/or consumer are notified of that fact, and an alternate arrangement would need to be made by the consumer to try to fund the project. However, if successful with a lender, then the selected lender would conduct a hard credit pull and proceed with the usual loan application process.

Additionally, in at least some further embodiments (or in other aspects), the present disclosure relates to an improved system and/or method that helps to identify the right lender for the right consumer and/or contractor in a particular example manner, as follows. First, the improved system or method considers which lenders the contractor has been underwritten with, and therefore are eligible lending partners. All lenders on the platform not meeting this criterion are removed from further consideration. Next, the improved system or method considers which lenders, based on the credit check (e.g., the “soft credit pull”), might be available or suitable as lenders to a particular consumer. The decision as to whether a particular consumer is eligible to work with a particular lender can be based on an algorithm that compares the FICO® score and debt-to-income ratio (and possibly one or more other factors of interest) of past approvals to those datapoints for each new consumer. The algorithm can be updated constantly as feedback on which consumers are approved and declined becomes available. All lenders not meeting these criteria can be removed from further consideration. Another step is submitting an application to the “first tier” lender (that is, the lender meeting the highest consumer credit standards). If rejected, the method moves to the second tier, and so on, until all lenders are exhausted. And then, when a match is returned, the method stops searching, and shows the consumer what loan programs (e.g., low interest, low payment, etc.) are available. If the consumer rejects those programs, the process ends. And finally, if the consumer accepts a loan option, the lender provides traditional loan paperwork directly to the consumer, and the consumer and lender complete the hard application process.

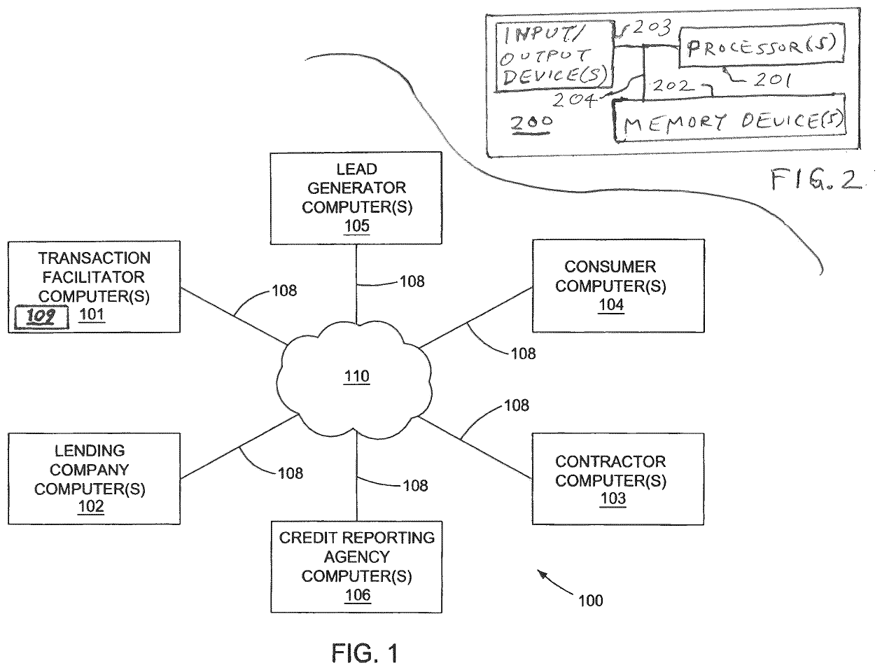

Referring to FIG. 1, a block diagram is provided to represent a system 100 for facilitating consumer lending in regard to home improvement projects in accordance with an example embodiment encompassed herein. The system 100 includes numerous computers (or computer systems) associated respectively with different parties, respectively. Each of the parties with which the respective computers are associated can be an individual (human being) or a company or other entity that owns, operates, controls, or otherwise is associated with the respective computer. Although the system 100 is shown to include multiple interconnected computers, it should further be appreciated that the system 100 is generally intended to be representative of a variety of connections or arrangements that can be established (and interactions that can occur or be performed) among various parties, where such interactions at least partly (or entirely) involve communications among the various computers respectively associated with the respective parties, to achieve consumer lending in regard to home improvement projects.

More particularly as illustrated, the system 100 includes each of one or more transaction facilitator computer(s) 101, one or more lending company computer(s) 102, one or more contractor computer(s) 103, one or more consumer computer(s) 104, one or more lead generator computer(s) 105, and one or more credit reporting agency computer(s) 106. Although the system 100 is shown in FIG. 1 to include one or more of each of the types of computers 101, 102, 103, 104, 105, and 106, depending upon the embodiment one or more of these types of computers need not be present. For example, in some embodiments, one or more lead generator computer(s) 105 need not be included as part of the system 100. Also, in other embodiments, one or more other types of computer(s) other than those shown in FIG. 1 can additionally or instead be present. Further, as described below in at least some embodiments encompassed herein, at least one (or possibly more than one, or each) of the transaction facilitator computer(s) 101 respectively includes an operates partly based a respective large-scale least recently used (LRU) cache (or cache memory) 109.

Additionally as shown, the system 100 is one in which the transaction facilitator computer(s) 101, lending company computer(s) 102, contractor computer(s) 103, consumer computer(s) 104, lead generator computer(s) 105, and credit reporting agency computer(s) 106 engage in communications with one another by way of the internet or World Wide Web (WWW) 110. The computers 101, 102, 103, 104, 105, and 106 can be connected to the internet (or WWW) 110 by way of one or more additional communication links 108. The additional communication links 108 can be, but need not be, considered part of the internet (or WWW) 216. Notwithstanding the manner in which the additional communication links 108 are shown in FIG. 1, it should be understood that the additional communication links 108 are representative of any arbitrary number of additional communication links that can be present depending upon the embodiment. Also, in other embodiments encompassed herein, one or more of the computer(s) 101, 102, 103, 104, 105, and 106, can be in communication with one another by way of communication links that do not involve the internet (or WWW) 108, such as Ethernet links, intranet links, satellite links, or other communication links.

Indeed, the present disclosure generally envisions and encompasses any of a variety of embodiments in which any of the computers 101, 102, 103, 104, 105, and 106 engage in communications with one another by way of any of a variety of communication links or media, including communication links or media that involve the internet (or WWW) as well as communication links or media other than, or in addition to, internet-based communication links or media. Further for example, the communication links or media that can be employed in various embodiments can include any of a variety of wired or wireless communication links or media involving electrical cables such as coaxial cables, fiber optics or other optical communications media or technologies, digital subscriber lines (DSLs), cellular technologies (e.g., 3G, 4G, 5G, or 6G), Bluetooth communications, Wi-Fi communications, radio wave, satellite, microwave, infrared, or other wired or wireless communications technologies.

Referring additionally to FIG. 2, in at least some embodiments encompassed herein, each of the transaction facilitator computer(s) 101, lending company computer(s) 102, contractor computer(s) 103, consumer computer(s) 104, lead generator computer(s) 105, and credit reporting agency computer(s) 106 can be generally understood as taking the form of a computer 200. As shown schematically by a block diagram provided in FIG. 2, the computer 200 includes one or more processor(s) (or processing device(s)) 201, one or more memory (or storage) device(s) 202, and one or more input and/or output (I/O) device(s) 203. Additionally as shown, the processor(s) 201, memory device(s) 202, and I/O device(s) 203 are in communication with one another, directly or indirectly, by way of one or more internal communication link(s) 204.

Each of the one or more processor(s) 201 (simply referred to as the processor(s) 201 below) can take any of a variety of forms depending upon the embodiment, and can include any of a variety of one or more systems, devices, or components that perform any of a variety of types of processing or calculation operations. For example, depending upon the embodiment, the processor(s) 201 can respectively be implemented by way of respective hardware devices or components, firmware, or software (including applications or apps) implemented upon hardware encompassed by the processors. Also for example, the processor(s) 201 can be or include one or more microprocessors, one or more microcomputers, or one or more other forms of processing devices such as application specific integrated circuits (ASICs) or programmable logic devices (PLDs). The processor(s) 201 can be operated in accordance with various programs or computer-executable instructions so as to perform any of a variety of different functions related to the performing of processing and taking of other actions as described herein, including actions that achieve or facilitate achieving funding for home improvement projects.

Additionally, the one or more memory device(s) 202 (simply referred to as the memory device(s) 202 below) can store any of a variety of types of information or data depending upon the embodiment or implementation. Among other things, the memory device(s) 202 can store software, programs, applications (or apps), or computer-executable instructions in accordance with which one or more of the processor(s) 201 operate. Also, as described further herein, the memory device(s) 202 can store any of a variety of information or data, including customer identification or contact (e.g., home/residence/work address, phone number, or email address) information or data, financial information or data, home improvement project description information or data, and/or other types of information or data. Further, the memory device(s) 202 can store additional information or data that is based upon or derived from (e.g., by performing processing) any of such types (or other types) of information or data.

The memory device(s) 202 can take any of a variety of forms or encompass any of a variety of different types of systems, devices, or components depending upon the embodiment. For example, in some embodiments, any one or more of the memory device(s) 202 can employ any of databases, magnetic disk storage, optical disk storage, random access memory (RAM) devices, read only memory (ROM) devices, compact disc read only memory (CD/ROM) devices, electrically erasable programmable read only memory (EEPROM) devices, or other forms of storage devices or computer-readable storage media. In some embodiments, the processing and memory functionality associated with the processor(s) 201 and memory device(s) 202 of any one or more of the transaction facilitator computer(s) 101, lending company computer(s) 102, contractor computer(s) 103, consumer computer(s) 104, lead generator computer(s) 105, and credit reporting agency computer(s) 106 can take the form of a single device that has both processing and memory capabilities (e.g., a processor-in-memory or PIM). Also, in at least some embodiments encompassed herein, one or more of the transaction facilitator computer(s) 101 can store data or information in one more cache memories. The large-scale LRU cache 109 mentioned above with reference to FIG. 1 should therefore be considered to be included as one of the memory device(s) 202 of FIG. 2.

In at least some embodiments, with respect to any of the transaction facilitator computer(s) 101, lending company computer(s) 102, contractor computer(s) 103, consumer computer(s) 104, lead generator computer(s) 105, and credit reporting agency computer(s) 106, one or both of the processing or memory functionality provided by the processor(s) 201 and/or memory device(s) 202 of the respective computer can be provided by way of multiple processing and/or memory systems, devices, or components that are located in a variety of physical locations or distributed among a variety of systems, or subsystems. Among other things, in at least some embodiments encompassed herein, one or more of the processor(s) and/or memory device(s) of any of the computer(s) 101, 102, 103, 104, 105, and 106 can be provided in or by a cloud computing system (e.g., implemented in the cloud) formed from or encompassing numerous processors and memory devices respectively located apart from one another (or distributed) at many separate and distinct locations.

Further with reference to FIG. 2, the I/O device(s) 203 can include any of a variety of systems, devices, or components that permit signals or information to be input to (received by) the computer 200 from, or output from the computer 200 for receipt by, one or more other computers, systems, devices, or components, or individuals (e.g., people interfacing with the computer 200). The I/O device(s) 203 permit the computer 200 to intercommunicate or interact with other computers, systems, devices, or components, or individuals. More particularly, the I/O device(s) 203 can for example include terminals or ports, wireless transceivers or Wi-Fi hotspots that facilitate wireless communications, and/or devices such as video displays or monitors, touch screens, keyboards, joysticks, mouse devices, microphones, and speakers. The I/O device(s) 203 can be located at the same or substantially the same locations as the processor(s) 201 and/or memory device(s) 202 of the computer 200, but also can be located remotely from the processor(s) 201 and/or memory device(s) 202 of the computer.

Further, it should be recognized that the computer 200 of FIG. 2 is representative of a variety of different types of computers (or computer devices or computer systems) that can be implemented depending upon the circumstance or embodiment. Such different types of computers represented by the computer 200 can include, for example, personal computers such as laptop, notebook, or desktop computers, or mobile devices such as smart phones, cellular telephones, hand held devices or handsets, smart wristwatches, or other mobile computing devices, mainframe computers, or computers associated with cloud computing systems. It should also be recognized that different ones of the computers 101, 102, 103, 104, 105, and 106 can respectively be of, or encompass multiple different computers of, these different types. For example, in one embodiment, some of the computer(s) 101, 102, 103, 104, 105, and 106 can be desktop or laptop computers, or mainframe computers, and others of the computer(s) 101, 102, 103, 104, 105, and 106 can be mobile devices.

Further for example, in at least some example embodiments, each of the consumer computer(s) 104 can respectively be a respective mobile device and/or a respective laptop, notebook, or desktop computer that is respectively operated by and associated with (e.g., owned by) a respective consumer who is seeking assistance with implementing one or more home improvement project(s). Also for example, each of the contractor computer(s) 103 can respectively be a respective mobile device and/or a respective laptop, notebook, or desktop computer that is respectively operated by and associated with (e.g., owned by) a respective contractor who is seeking to assist one or more consumer(s) with implementing one or more home improvement project(s). Additionally for example, respective ones of the lending company computer(s) 102 can respectively be large computer(s) (e.g., mainframe computer(s)) of lending companies such as banks or other financial institutions that can provide loans (for example, credit unions), and likewise respective ones of the credit reporting agency computer(s) 106 can respectively be large computer(s) (e.g., mainframe computer(s)) of credit reporting agencies such as Equifax of Atlanta, Georgia, TransUnion of Chicago, Illinois, or Experian plc of Dublin, Ireland.

Further with respect to FIG. 1 and FIG. 2, in at least some embodiments encompassed herein, one or more of (or any of) the transaction facilitator computer(s) 101, lending company computer(s) 102, contractor computer(s) 103, consumer computer(s) 104, lead generator computer(s) 105, and credit reporting agency computer(s) 106 can interact with one or more others of these computers in accordance with a client-server model or architecture. Additionally for example, in at least some embodiments encompassed herein, one or more of the computers 101, 102, 103, 104, 105, and 106 can interact with one or more others of these computers in a peer-to-peer manner.

Further for example, in at least some embodiments encompassed herein, the one or more transaction facilitator computer(s) 101 includes a first one of the transaction facilitator computer(s) that is or includes a server computer. As interactions occur between consumer(s) and contractor(s) who are seeking to implement, and achieve funding of, home improvement projects, communications and interactions occur between one(s) of the contractor computer(s) 103 and one(s) of the consumer computer(s) 104. In turn, one or more of the contractor computer(s) 103 and/or one or more of the consumer computer(s) 104 can engage in communications and interactions with the first transaction facilitator computer as client computer(s), in an effort to obtain funding for the home improvement projects. Those ones of the contractor computer(s) 103 and the consumer computer(s) 104 which engage in communications with the first one of the transaction facilitator computer(s) 101 can do so in accordance with a client-server model of communications. In contrast, in at least some such embodiments, the transaction facilitator computer(s) 101 can engage in communications and interactions with the lending company computer(s) 102 and/or the credit reporting agency computer(s) 106 on a peer-to-peer basis.

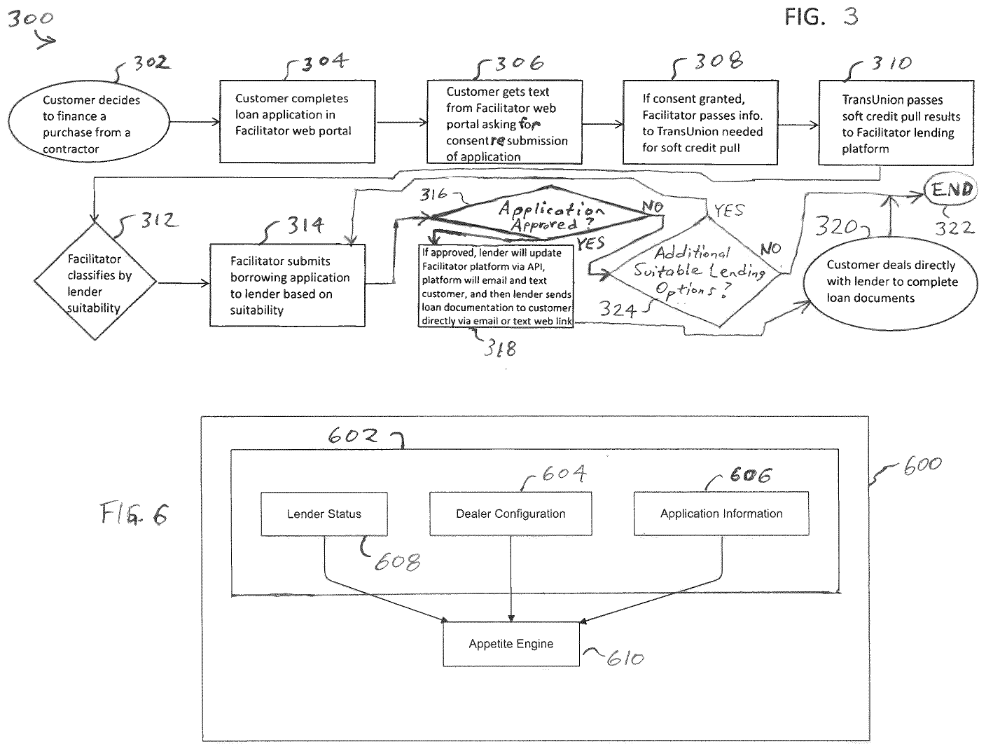

The present disclosure envisions numerous different methods of operation and use cases in which embodiments of systems encompassed herein such as the system 100 of FIG. 1 are employed to achieve, or facilitate the achieving of, funding for home improvement projects. In this regard, FIG. 3 is a flow chart (or financing process chart) shows example steps of a first example method 300 for achieving funding for a home improvement project. As shown, the first example method 300 begins at a first (start) step 302, at which a customer decides to finance a purchase from a contractor. Upon the customer making that decision, then at a second step 304 the customer completes a loan application in a facilitator web portal. In the present example embodiment, the facilitator web portal can be provided as a web page on the consumer computer 104 associated with (e.g., owned by) the customer, which can for example be a mobile device. The web page can be transmitted to the consumer computer 104 of the customer from the transaction facilitator computer 101 when the customer navigates to the website of the facilitator company that is associated with the transaction facilitator computer.

To complete the loan application, the customer types in, selects options from (for example by selecting items from drop-down menus), attaches files, or otherwise enters in information so as to address all questions or information queries specified by the web page (or by form(s) specified on the web page). Upon completion/provision of all necessary information or data, the customer will provide a command (e.g., by pressing a button on the mobile device or providing a verbal command recognized by the mobile device) causing the completed loan application information to be communicated from the consumer computer (mobile device) 104 to the transaction facilitator computer 101.

In an alternate embodiment, the facilitator web portal can be presented to a customer via one of the contractor computer(s) associated with (e.g., owned or operated by) the contractor (or sales designer or representative) with which the customer is working. For example, upon receiving an appropriate expression of interest in pursuing a home improvement project from a customer, the contractor can navigate the contractor computer (e.g., a mobile device) to the website of the facilitator and enter into communications with the transaction facilitator computer (101) of the facilitator so as to bring up the facilitator web portal, and particularly the web page including the loan application, on the contractor computer. The contractor can then ask the customer to provide all necessary information or data for purposes of completing the loan application directly via the contractor computer (e.g., the contractor's mobile device) and, upon that information/data being provided, the customer (or contractor) can provide a command (e.g., by pressing a button or providing a verbal command) causing the completed loan application information to be communicated from the contractor computer 103 to the transaction facilitator computer 101.

Upon completion of the second step 304, the process of FIG. 3 advances to a third step 306, at which the customer receives a text (e.g., text message) from the facilitator web portal asking for consent regarding submission of the loan application (and associated information) to a credit reporting agency. In the present embodiment, the text is sent by the transaction facilitator computer associated with the facilitator (transaction facilitator company) for receipt and display by the consumer computer (e.g., mobile device) of the consumer. The consent language of the text, which will be integrated into the application according to which the transaction facilitator computer 101 operates, can for example be as follows: “To better assist you in finding the right lender, Facilitator will initially conduct a soft credit check. A soft credit inquiry does not affect your credit score, will not be visible to creditors, and will not impact your creditworthiness. This soft credit inquiry allows us to match you with a lender that may be able to provide financing for your home improvement project. By proceeding, you authorize us to access and review your credit information. Please note that, depending on the lender we match you with, a hard credit inquiry may be conducted now or at a later time by that lender. By selecting the box below and continuing, you acknowledge and consent to the soft credit check, and hard credit check, if required by the lender you are matched to.”

In response to receiving the text, the customer can provide a reply or signal indicating that consent is granted, such as for example by sending a reply text in the same t text chain that indicates consent (e.g., by texting “Y”). In other embodiments, instead of a text being sent, the facilitator can instead send another message for receipt by the customer in which consent is requested, including for example an email message requesting consent, or the facilitator can contact the customer in another manner (e.g., by automatically telephoning the customer with an automated voice message in response to which the customer is asked to communicate a reply indicating consent).

Next, at a fourth step 308, it is presumed for purposes of the example method 300 of FIG. 3 that the customer grants consent and has provided an appropriate message or signal indicating consent for receipt by the transaction facilitator computer 101 (if consent is not granted, then the method would end at the third step 306). If consent is granted, the transaction facilitator computer 101 in turn passes information (e.g., some of the information provided in the customer's loan application) to one of the credit reporting agency computers 106, such as a credit reporting agency computer associated with TransUnion (although TransUnion is mentioned in FIG. 3 as an example credit reporting agency, the method 300 can also involve other credit reporting agencies). The particular information that is sent from the transaction facilitator computer 101 to the credit reporting agency computer 106 particularly will include that information which is needed in order for the credit reporting agency to perform a soft credit pull. Then, at a fifth step 310, upon that information being received by the credit reporting agency computer 106, that information is utilized/processed by the credit reporting agency computer (or otherwise by the credit reporting agency) to perform the soft credit pull, and then the soft credit pull results are passed from the credit reporting agency (again, e.g., TransUnion) to the transaction facilitator company lending platform. More particularly, in the present embodiment, the soft credit pull results are sent from the credit reporting agency computer 106 to the transaction facilitator computer 101.

Upon completion of the fifth step 310, the method 300 of FIG. 3 then advances to a sixth step 312, at which the facilitator company evaluates and classifies different lending option(s) that are potentially appropriate (or suitable, or viable) for the customer in view of the previously-submitted loan application and soft credit pull results (and possibly other factors, such as characteristics of the home improvement project under consideration). In some circumstances, this evaluation and classification can be performed automatically by the transaction facilitator computer 101. As a result of the sixth step 312, the transaction facilitator computer 101 arrives at an ordering or ranking of two or more different lending option(s) that are appropriate (or suitable) for the customer. Further, suitability classification for example can involve providing classification into three groups: suitable for 1st Look Lender, 2nd Look Lender, or 3rd Look Lender (and/or can involve consideration of preferred consumer credit standards). Or, if it is determined that merely one lending option(s) is appropriate (or suitable), then the result of the sixth step 312 will be the identification of that one lending option.

More particularly with respect to the sixth step 312, it should be appreciated that the transaction facilitator computer 101 has the ability to communicate with a variety (or plurality) of different ones of the lending company computer(s) 102, is thereby able to access information regarding the lending capabilities and requirements of different lending companies associated with those lending company computer(s). Indeed, in at least some implementations, the transaction facilitator computer 101 of a given facilitator is able to automatically and repeatedly communicate with the lending company computer(s) 102 of different lending companies to obtain such information regarding the lending capabilities and requirements of such lending companies on a frequently-updated or even real-time basis. Based upon this information regarding the lending capabilities and requirements of different lending companies, the transaction facilitator computer 101 (as programmed) is able to evaluate the appropriateness or suitability for a given customer of different lending options available from those lending companies, in view of the customer's loan application and soft credit pull results (and possibly other factors).

Upon completion of the sixth step 312, then at a seventh step 314 the facilitator further submits a borrowing (or loan) application to an appropriate lending company based upon based upon the determination made at the sixth step 312 regarding which lending option is appropriate or suitable for the customer. If a particular lending option from among several lending options was determined to be most appropriate or suitable at the sixth step 312, then the facilitator submits the borrowing application to the lender (lending company) offering that lending option that was determined to be most appropriate or suitable. If merely a single lending option was determined to be appropriate or suitable, then the facilitator submits the borrowing application to the lender (lending company) offering that single lending option. The operation represented by the seventh step 314 in the present embodiment again can be one that is performed automatically by the transaction facilitator computer 101 submitting the borrowing application directly to the lending company computer 102 of the lending company that is offering the appropriate/suitable lending option.

In response to being contacted with the borrowing application at the seventh step 314, the lending company that is offering the appropriate/suitable lending option determines whether the borrowing application is approved, at an eighth step 316. The determination made at the eighth step 316 can, in at least some embodiments, be made automatically by the lending company computer 102 of the lending company that is offering the appropriate/suitable lending option.

If the borrowing application is approved, then the method 300 of FIG. 3 proceeds to a ninth step 318, at which in the present embodiment several actions are performed. First, as part of the ninth step 318, the lending company computer 102 (again associated with the lender/lending company that is offering the appropriate/suitable lending option) sends a communication to the transactional facilitator computer 101 of the facilitator indicating that the borrowing application has been approved. In the present embodiment, the lender (or lending company computer 102 thereof) will update the facilitator platform (provided by the transaction facilitator computer 101) via an application programming interface (API).

Second, also as part of the ninth step 318, upon the transaction facilitator computer 101 receiving the communication regarding the approval of the borrowing application, the transaction facilitator computer will in turn text (or otherwise notify) the customer of that approval, by sending an appropriate text (or other message) to the consumer computer (e.g., mobile device) 104 of the customer requesting the loan. Third, additionally as part of the ninth step 319, the lending company computer 102 (again associated with the lender/lending company that is offering the appropriate/suitable lending option) sends a further communication with loan documentation to the customer directly, without passing through the transaction facilitator computer 101. The loan documentation can be sent, for example, via email. Alternatively, the lending company computer 102 can send a text to the consumer computer 104 providing a text web link such that, upon the customer clicking on the web link, the loan documentation will be downloaded to the consumer computer for review by the customer.

Upon the loan documentation being provided to the consumer computer (e.g., mobile device) 104 of the customer, then at a tenth step 320 the customer deals directly with the lend to complete the loan documents and secure the loan/financing for the home improvement project. The completion of the loan documents can again be completed at least in part by communications between the consumer computer (e.g., mobile device) 104 of the customer and the lending company computer 102 associated with the lender that approved the borrowing application and will be providing the loan to the customer. Upon completion of the loan documents, the method 300 ends at an end step 322.

However, if the borrowing application is not approved at the eighth step 316, then instead of proceeding to the ninth step 318, the method instead advances to an additional step 324. At the additional step 324, it is determined by the transaction facilitator computer 101 whether there remain any one or more other lending options that were determined previously (e.g., at the sixth step 312) as being appropriate or suitable. If there is or are any one or more other lending options, then the method 300 returns to the seventh step 314, at which the transaction facilitator computer 101 submits a borrowing application to the lending company computer 102 associated with the lender that was determined previously as providing the next most appropriate/suitable lending option (next most appropriate/suitable relative to the lending option for which the borrowing application was most recently rejected at the eighth step 316.

Upon the repeating of the seventh step 314, then the method again returns to the eighth step 316, at which the borrowing application is either approved or not approved by the lending company computer 102 corresponding to the next most appropriate/suitable lending option. If the borrowing application is approved, then the ninth step 318 and the tenth step 320 are performed as described above, except insofar as the lending company computer 102 interacting with the consumer computer 104 and the contractor computer 103 is that one of the lending company computers that is associated with the lending company that has approved the borrowing application and with which the customer is, upon completion of the loan documents at the tenth step 320, able to obtain the sought-after loan.

Alternatively, if at the additional step 324 it is determined by the transaction facilitator computer 101 there are no other lending options that were determined previously (e.g., at the sixth step 312) as being appropriate or suitable, then the method 300 proceeds directly to, and concludes at, the end step 322. Thus, it can be appreciated from the additional step 324 and related interplay with the seventh step 314, eighth step 316, ninth step 318, and tenth step 320 that, to the extent that a borrowing application is not approved at the eighth step 316 by one of the lending company computers 102, then the method 300 proceeds in a manner by which one or more additional borrowing application(s) are submitted successively to additional one(s) of the lending company computers 102 for approval (with each successive additional one of the lending company computers being associated with a successively less appropriate/suitable lending option for the customer), until one of those additional borrowing application(s) is approved. As soon as one of the borrowing application(s) is approved, the ninth step 318 and the tenth step 320 are performed so that a loan is provided to the customer upon completion of the tenth step 320.

However, if all lending options identified at the sixth step 312 are exhausted without there being approved any borrowing application, signifying that all available lenders are willing to pass on granting a loan to the customer, then the method ends without a loan having been completed. (Further, in the event no appropriate or suitable lending options are identified at the sixth step 312, then the method also can end without a loan having been completed.) Although not illustrated in FIG. 3, if no lenders are found, the transaction facilitator computer (or platform) 101 can in such case notify the contractor (or contractor computer 103, and simultaneously, the transaction facilitator computer can send a communication via text for receipt by the consumer computer 104 that can read as follows: “We're sorry, no lenders have been found for your application. Please discuss cash or credit card payment options with your sales representative, or try again at a later date.”

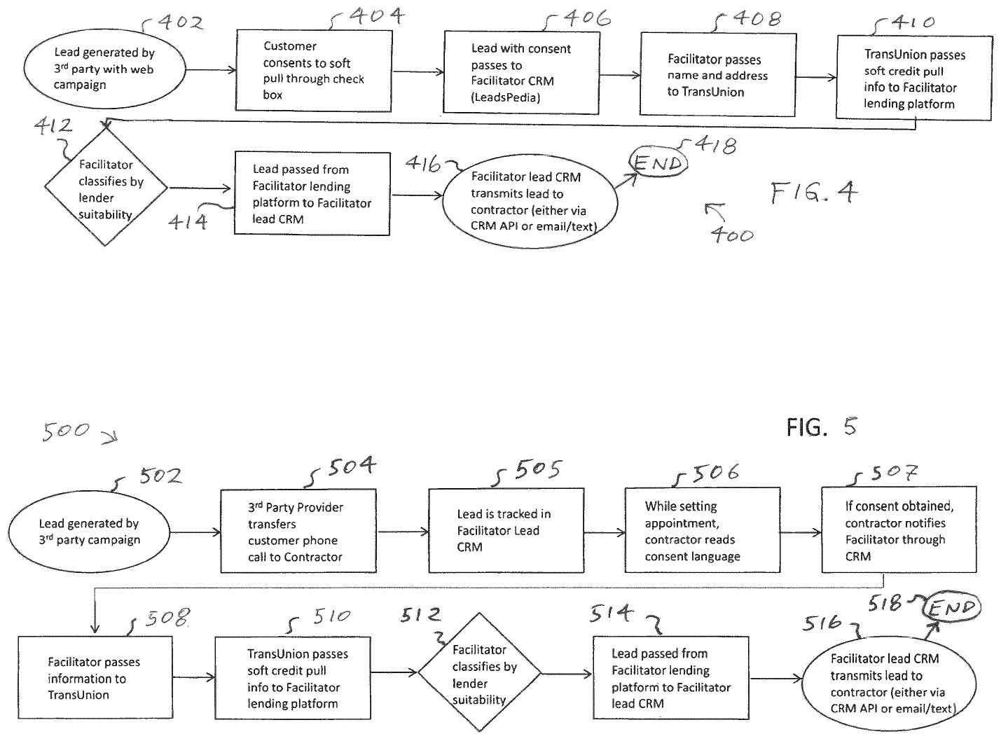

Turning next to FIG. 4, in at least some embodiments, the present disclosure relates to embodiments in which systems encompassed herein (such as the system 100 of FIG. 1) also involve lead generation in addition to achieving (or facilitating the achieving of) funding for home improvement projects. In this regard, FIG. 4 is a flow chart (or web lead process chart) that shows example steps of a second example method 400 for generating and utilizing a web lead for a home improvement project. As shown, the second example method 400 begins at a first (start) step 402, at which a lead concerning a home improvement project is generated by a third party with a web campaign. Such a lead can be generated as a result of a web campaign managed by one (or more) of the lead generator computer(s) 105 associated with (e.g., owned or operated by) one or more lead generator(s). Such a lead particularly entails identifying a customer who is interested in possibly pursuing a home improvement project.

Upon the lead being generated at the first step 402, then at a second step 404 the customer corresponding to the lead is asked to consent to a soft credit pull and, in response, such customer consent is provided back to the lead generator company. Such a consent can be obtained from the customer by the lead generator computer 105 associated with the lead generator company, by communicating with the consumer computer (e.g., a mobile device) 104 associated with the customer. For example, a message can be sent from the lead generator computer 105 to the consumer computer 104 asking that the customer provide an input such as checking a box indicating the customer's consent and, upon the customer providing such an input, the consumer computer can then transmit a signal indicating consent back to the lead generator computer 105.

Such a message that is sent at the second step 404 from the lead generator computer 105 to the consumer computer 104 can include soft credit pull consent language that is integrated into consent to contact language, and can be as follows: “To better assist you in finding the right contractor, we would like to conduct a soft credit inquiry as part of our evaluation process. A soft credit inquiry does not affect your credit score, will not be visible to creditors, and will not impact your creditworthiness. You do not need to provide your social security number or other sensitive information. This inquiry allows us to match you with contractors who may be able to offer you special financing programs. By proceeding, you authorize us to access and review your credit information. Please note that a hard credit inquiry may be conducted later by a lender, should you choose to use a financing option. By selecting the box below and continuing, you acknowledge and consent to the soft credit inquiry.”

In at least some embodiments encompassed herein, and with respect to the method 400 of FIG. 4, a web campaign managed by one or more of the lead generator computer(s) 105 can be performed in accordance with directions or contractually-specified obligations specified by a transaction facilitator company. The arrangement between the lead generator company and the transaction facilitator company can be one according to which the transaction facilitator will pay the lead generator company for example on a per lead basis, or on a per campaign basis. Also in accordance with such an arrangement, when leads arise, such leads in turn are communicated by the lead generator company to the transaction facilitator company.

With this being the case, in the method 400, after a customer corresponding to a lead has consented to a soft credit pull, then at a third step 406 the lead generator computer 105 associated with the lead generator company that generated that lead sends one or more lead-related signal(s) to transaction facilitator computer 101 associated with the transaction facilitator company with which the lead generator company has a relationship. The lead-related signal(s) that are communicated include lead information and also include the indication of consent to a soft credit pull that was provided by the customer corresponding to the lead. The lead information and consent indication (lead with consent) that is communicated to the transaction facilitator computer 101 can pass into customer relations management (CRM) software of the transaction facilitator computer, as made possible for example by software offered by LeadsPedia, Inc. of Franklin, Tennessee.

In the present example embodiment, given that customer consent to a soft credit pull has been approved, the transaction facilitator computer 101 in turn at a fourth step 408 passes along customer information to one of the credit reporting agency computers 106, such as a credit reporting agency computer associated with TransUnion (although TransUnion is mentioned in FIG. 4 as an example credit reporting agency, the method 400 can also involve other credit reporting agencies). The particular information that is sent from the transaction facilitator computer 101 to the credit reporting agency computer 106 particularly will include that information which is needed in order for the credit reporting agency to perform a soft credit pull (e.g., customer name and address information). Then, at a fifth step 410, upon that information being received by the credit reporting agency computer 106, that information is utilized/processed by the credit reporting agency computer (or otherwise by the credit reporting agency) to perform the soft credit pull, and then the soft credit pull results are passed from the credit reporting agency (again, e.g., TransUnion) to the transaction facilitator company lending platform. More particularly, in the present embodiment, the soft credit pull results are sent from the credit reporting agency computer 106 to the transaction facilitator computer 101.

Upon completion of the fifth step 410, the method 400 of FIG. 4 then advances to a sixth step 412, at which the facilitator company evaluates and classifies different lending option(s) that are potentially appropriate (or suitable, or viable) for the customer in view of the soft credit pull results (and possibly other information or factors, such as characteristics of the home improvement project under consideration). In some circumstances, this evaluation and classification can be performed automatically by the transaction facilitator computer 101. As a result of the sixth step 412, the transaction facilitator computer 101 arrives at an ordering or ranking of two or more different lending option(s) that are appropriate (or suitable) for the customer. Further, suitability classification for example can involve providing classification into three groups: suitable for 1st Look Lender, 2nd Look Lender, or 3rd Look Lender. Or, if it is determined that merely one lending option(s) is appropriate (or suitable), then the result of the sixth step 412 will be the identification of that one lending option.

Following the sixth step 412, at a seventh step 414 the lead information is passed from a lending platform to the transaction facilitator computer 101 to a facilitator lead CRM. Subsequently, at an eighth step 416, the facilitator lead CRM transmits the lead to a contractor or, in at least some embodiments, to one (or more) of the contractor computer(s) 103 associated with a contractor. The lead information can be communicated for example by a CRM API, by email, or by text. Upon the performing of the eighth step 416, then the method 400 ends at an end step 418. Although the method 400 is shown to end at the end step 418, it should be further appreciated that, following the end step 418 (or the eighth step 416), the method can continue (or an additional method can be performed) with additional steps by which funding is achieved in regard to the home improvement project based at least in part (or indirectly) upon the lead information provided to the contractor computer(s) 103 (for example, additional steps corresponding to the seventh step 314, eighth step 316, ninth step 318, and tenth step 320 of FIG. 3).

Notwithstanding the method 400 of FIG. 4, the present disclosure also encompasses other methods involving lead generation. In this regard, FIG. 5 is a flow chart (or phone lead process chart) that shows example steps of a third example method 500 for generating and utilizing a phone lead for a home improvement project. As shown, the third example method 500 begins at a first (start) step 502, at which a lead concerning a home improvement project is generated by a third party with a campaign. Such a lead can be generated as a result of a campaign managed by one (or more) of the lead generator computer(s) 105 associated with (e.g., owned or operated by) one or more lead generator(s) (who can be also referred to as third party providers). Such a lead particularly entails identifying a customer who is interested in possibly pursuing a home improvement project, and in this embodiment can also arise particularly as a result of a phone conversation. It is envisioned that, in some implementations, the lead generator computer(s) 105 can serve to connect human lead generation representatives with prospective customers (e.g., by identifying customer phone numbers and initiating phone connections with those customers) or alternatively employ robo-call type technologies (including, for example, artificial intelligence-based technologies) to initiate and conduct conversations with prospective customers.

Upon the lead being generated at the first step 502, then at a second step 504 the lead generator company (or third party provider) transfers the customer phone call to a contractor, for further conversations or other communications with the customer. Such further conversations or communications can for example involve a further conversation between the customer and a human being who is the contractor (or sales designer or representative) or is affiliated with a contractor company, and/or can also involve conversations or other communications between the customer and an automated system (including, for example, an artificial intelligence-based system) associated with the contractor. Next, at a third step 505, the lead generated at the first step 502 is also passed along and tracked in a facilitator lead CRM available from and managed by a transaction facilitator company. The facilitator lead CRM for example can be stored in one (or more) of the transaction facilitator computer(s) 101 that are associated with (e.g., owned and operated by) the transaction facilitator company. The transaction facilitator company can pay the third party lead generator company for example on a per lead basis.

Additionally, as part of the further conversations or communications with the customer (e.g., in accordance with the second step 504), an appointment can be set between the contractor and the customer and, during the setting of this appointment, the contractor can read or communicate consent language regarding a soft credit pull to the customer at a fourth step 506. Again, the consent language can be read, for example over the phone, by a human being that is the contractor or is affiliated with the contractor company. Such soft credit pull consent language can be integrated into consent to contact language, and can for example be as follows: “To better assist you in finding the right contractor, we would like to conduct a soft credit inquiry as part of our evaluation process. A soft credit inquiry does not affect your credit score, will not be visible to creditors, and will not impact your creditworthiness. You do not need to provide your social security number or other sensitive information. This inquiry allows us to match you with contractors who may be able to offer you special financing programs. By proceeding, you authorize us to access and review your credit information. Please note that a hard credit inquiry may be conducted later by a lender, should you choose to use a financing option. By selecting the box below and continuing, you acknowledge and consent to the soft credit inquiry.”

Then, at a fifth step 507, if consent is obtained from the customer, then the contractor notifies the transaction facilitator company. In the present example embodiment, the notification of the transaction facilitator company can be performed by a communication of the consent from the contractor computer 103 associated with the contractor and the transaction facilitator computer 101 associated with the transaction facilitator company. The lead information and consent indication (lead with consent) that is communicated to the transaction facilitator computer 101 in accordance with the third step 505 and the fifth step 507 can pass into customer relations management (CRM) software of the transaction facilitator computer 101.

In the present example embodiment, given that customer consent to a soft credit pull has been approved, the transaction facilitator computer 101 in turn at a sixth step 508 passes along customer information to one of the credit reporting agency computers 106, such as a credit reporting agency computer associated with TransUnion (although TransUnion is mentioned in FIG. 5 as an example credit reporting agency, the method 500 can also involve other credit reporting agencies). The particular information that is sent from the transaction facilitator computer 101 to the credit reporting agency computer 106 particularly will include that information which is needed in order for the credit reporting agency to perform a soft credit pull (e.g., customer name and address information). Then, at a seventh step 510, upon that information being received by the credit reporting agency computer 106, that information is utilized/processed by the credit reporting agency computer (or otherwise by the credit reporting agency) to perform the soft credit pull, and then the soft credit pull results are passed from the credit reporting agency (again, e.g., TransUnion) to the transaction facilitator company lending platform. More particularly, in the present embodiment, the soft credit pull results are sent from the credit reporting agency computer 106 to the transaction facilitator computer 101.

Upon completion of the seventh step 510, the method 500 of FIG. 5 then advances to an eighth step 512, at which the facilitator company evaluates and classifies different lending option(s) that are potentially appropriate (or suitable, or viable) for the customer in view of the soft credit pull results (and possibly other information or factors, such as characteristics of the home improvement project under consideration). In some circumstances, this evaluation and classification can be performed automatically by the transaction facilitator computer 101. As a result of the eighth step 512, the transaction facilitator computer 101 arrives at an ordering or ranking of two or more different lending option(s) that are appropriate (or suitable) for the customer. Further, suitability classification for example can involve providing classification into three groups: suitable for 1st Look Lender, 2nd Look Lender, or 3rd Look Lender. Or, if it is determined that merely one lending option(s) is appropriate (or suitable), then the result of the eighth step 512 will be the identification of that one lending option.

Following the eighth step 512, at a ninth step 514 the lead information is passed from a lending platform of the transaction facilitator computer 101 to a facilitator lead CRM. Subsequently, at a tenth step 516, the facilitator lead CRM transmits the lead to a contractor or, in at least some embodiments, to one (or more) of the contractor computer(s) 103 associated with a contractor. The lead information can be communicated for example by a CRM API, by email, or by text. Upon the performing of the tenth step 516, then the method 500 ends at an end step 518. Although the method 500 is shown to end at the end step 518, it should be further appreciated that, following the end step 518 (or the tenth step 516), the method can continue (or an additional method can be performed) with additional steps by which funding is achieved in regard to the home improvement project based at least in part (or indirectly) upon the lead information provided to the contractor computer(s) 103 (for example, additional steps corresponding to the seventh step 314, eighth step 316, ninth step 318, and tenth step 320 of FIG. 3).

The exact manner in which phone conversations can occur in which leads are generated and sales processes advance can take a variety of forms and/or possibly follow various scripts. As one example, a script sample for a Phone call lead transfer can be as follows:
Contractor: Hello, Ms. Smith, this is contractor XYZ, we understand you are interested in our product, and that you are located at 123 Main Street in Anytown, Wisconsin?
Consumer: Yes, thank you.
Contractor: We have a sales rep in your area next Tuesday. Shall I have him stop by around 5 pm?
Consumer: That works, thank you.
Contractor: Fantastic. Joe Smith will be there then. Also, we offer a number of financing options. If you're interested, we can run what is known as a “soft credit inquiry”, which will help Joe find the right financing option for you. This will not affect your credit score, will not be visible to creditors, and will not impact your creditworthiness. You do not need to provide your social security number or other sensitive information; we only need your name and address. By proceeding, you authorize us to access and review your credit information. Please note that a hard credit inquiry may be conducted later by a lender, should you choose to use a financing option. Would you authorize us to proceed?
Consumer: Yes please.
Contractor: Fantastic, Joe will be there next Tuesday and can discuss financing further then.

Also as a further example, a script sample for a Sales process can be as follows:
Contractor: So, it looks like you're going to go with the Model 123 Walk-In Shower. We do have financing options available, would you be interested in those?
Consumer: Yes, please.
Contractor: Great. We have three financing options, a lowest payment option, and lowest interest option, and a special 12 months, same as cash option.
Consumer: I'd like to go with the low interest option.
Contractor: Fantastic. To find the best options for you, please fill out this application form. [See screenshots]. To better assist you in finding the right lender, we will initially conduct a soft
credit check, which doesn't impact your credit. However, just so you know, depending on the lender we match you with, they may require a hard credit check, which may appear on your
credit report. So, please make sure to read this disclosure. [See Screenshots] After you've read this, you'll get a text or email, your preference, and you can confirm that you've read the disclosure. [submits form]
Option 1: Contractor: OK, fantastic. It looks like you've been approved. The Bank will email or text you loan documents for you to sign. Most of the information should be complete already, but please check it to make sure it's ok. Once you've signed, we'll get you on the installation calendar.
Option 2: I'm sorry, but no lenders have been found for your application. We could take a check or credit card, or we can try again at a later date.

It will be appreciated from the sixth step 312 of FIG. 3, the sixth step 412 of FIG. 4, and the eighth step 512 of FIG. 5 that, in at least some embodiments encompassed herein, a facilitator company evaluates and classifies different lending option(s) that are potentially appropriate (or suitable, or viable) for the customer in view of the soft credit pull results and possibly other information or factors. Such an evaluation and classification process can generate an ordering or ranking of two or more different lending option(s) that are appropriate (or suitable) for the customer when two or more different lending option(s) are appropriate (or suitable). Further, suitability classification for example can involve providing classification into three groups: suitable for 1st Look Lender, 2nd Look Lender, or 3rd Look Lender. Or, if merely one lending option proves to be appropriate (or suitable) for the customer, then such evaluation and classification process can result in the identification of that single lending option.

In at least some such embodiments, such an evaluation or classification process is performed (or performed at least partly) by the large-scale LRU cache 109 shown in FIG. 1. More particularly with respect to FIG. 6, in an example embodiment, one of the transaction facilitator computer(s) 101 associated with (e.g., owned or operated by) a transaction facilitator company can take the form of a server computer 600. The server computer 600 can for example be a Antsle one D or Antsle one XD (or XD Pro or XD Ultra) cloud server computer (or private cloud server computer) available from Antsle, Inc. of Las Vegas, Nevada. The server computer 600 in the present embodiment is configured to operate in a virtualized manner, such as through the use of virtualization software available from VMware LLC of Palo Alto, California, and in accordance with a microservices architecture. Such virtualized operation, and microservices architecture, are desirable from the standpoint of capacity management, and allow for higher throughput (e . . . , in terms of user authentication. Nevertheless, in alternate embodiments, other manners of operation and architectures can be employed by a server computer, such as (for example) a monolithic architecture.

Further, in the example embodiment of FIG. 6, the server computer 600 includes (or supports therewithin) a large-scale LRU cache 602 that corresponds to the large-scale LRU cache 109 of FIG. 1. The large-scale LRU cache 602 operates to store active dealer configuration information 604, application information 606, and lender status flags 608. During operation of the server computer 600, as will be described in further detail below, the server computer 600 operates to perform an evaluation and classification process corresponding to any of the sixth step 312, the sixth step 412, and the eighth step 512 at least in part by operating in accordance with (or as) an appetite engine (or appetite engine application) 610. When operating in accordance with the appetite engine 610, the appetite engine pulls information from the large-scale LRU cache 602, particularly during building and execution phases, including the active dealer configuration information 604, the application information 606, and the lender status flags 608.

In the present example embodiment, the dealer configuration information 604 can be provided by a dealer, which (with the help of the transaction facilitator company) can configure the following rules: (1) Available Lenders; (2) Lender Order; (3) Lending costs (some programs charge dealers increasing fees); and (4) Credit Chopping Rules (skip lenders that chop >% or specific $ amount). As for the lender configuration (or the lender status flags 608), the lender configurations can use the following rules: (1) Credit Floor; (2) DTI; (3) Location; (4) Income; (5) Title Rules; and (6) Credit Entries (Bankruptcies, etc.).

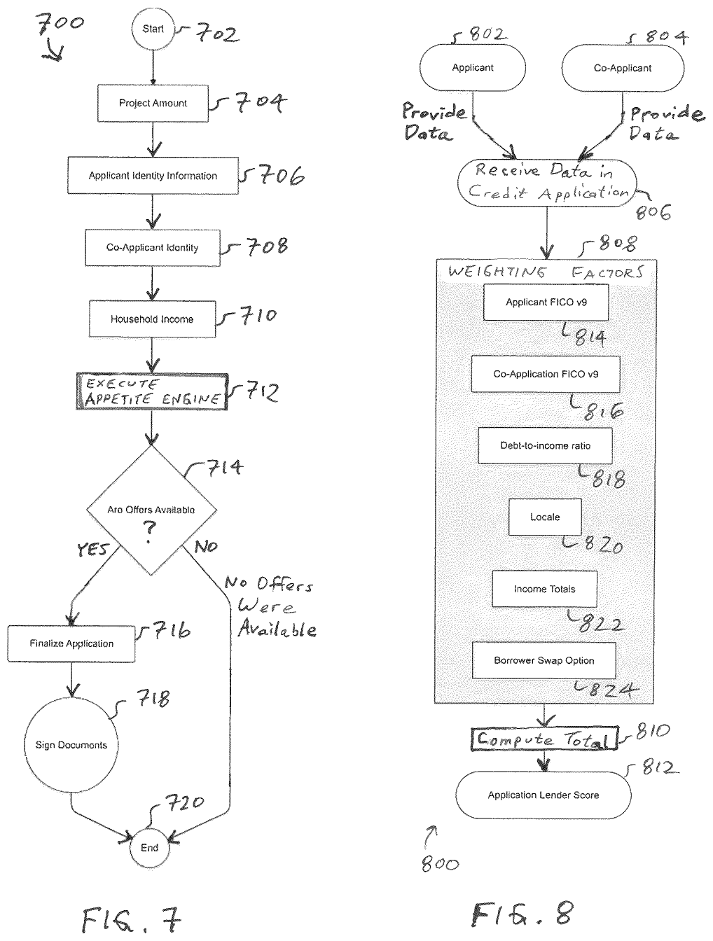

Turning to FIG. 7 and FIG. 8, respectively, first and second additional flow charts are provided therein, respectively, to illustrate example steps of a fourth example method 700 and a fifth example method 800. The fourth example method 700 and the fifth example method 800 can be performed by systems such as the system 100 of FIG. 1 to achieve, or facilitate the achieving of, funding for home improvement projects, particularly when the system includes the server computer 600 including the large-scale LRU cache 602 and the appetite engine 610 described with reference to FIG. 6. More particularly with respect to FIG. 7, the method 700 begins at a start step 702, which is followed by a first step 704, a second step 706, a third step 708, and a fourth step 710, respectively, which involve the receipt by the server computer 600 of project amount information, applicant (customer) identity information, co-applicant-identity information (if there is any co-applicant), and household income information (e.g., regarding the customer's household income), respectively. The start step 702 can be considered to correspond to the first step 302 of the method 300. Also, the first, second, third, and fourth steps 704, 706, 708, and 710 can be considered to correspond to (or be encompassed by) the second step 304 of the method of 300, at which the customer completes the loan application, and which is representative of a credit application process.

Upon receiving the various types of information represented by the first, second, third, and fourth steps 704, 706, 708, and 710, the method 700 of FIG. 7 proceeds to a fifth step 712, at which the server computer 600 (of the transaction facilitator computer 101) begins to operate, or operates, in accordance with (or as) the appetite engine 610. In general, the appetite engine 610 operates to make decisions and causes workflow to proceed. The appetite engine 610 is programmed to operate to reflect (or “knows”) generalized underwriting rules, and operates to call out to lenders to see if lenders will accept a particular loan opportunity with a given customer in the context of a given home improvement project. Subsequent to the fifth step 712, the method 700 then additionally operates further in accordance with the appetite engine 610 to perform a sixth step 714, a seventh step 716, an eighth step 718, and an end step 720.

More particularly, the fifth (execute appetite engine) step 712, plus the related sixth step 714, seventh step 716, and eighth step 718 performed in accordance with the appetite engine 610, can be understood to have or be broken into three stages or phases, namely: a plan phase; a build phase; and an execute phase. During the plan phase, the appetite engine 610 (e.g., the server computer 600 of the transaction facilitator computer 101, operating in accordance with the appetite engine) evaluates the customer/applicant details and calculates an application score for every lender on (or available via) the transaction facilitator company (or transaction facilitator company platform) with which the server computer 600 (and the transaction facilitator computer 101) is associated. Additionally, during the build phase, the server computer 600 arranges all configurations, application facts, and statuses of the lenders and operational systems. Further, during the execution phase, the server computer 600 then interacts with other appropriate computers, such as one(s) of the lending company computer(s) 102, and the consumer computer (e.g., a mobile device) of the customer, so as to execute loans with those of the lenders that are applicable and, in the order, specified by the dealer configuration.

Further with respect to the method 700 of FIG. 7, the sixth step 714, the seventh step 716, the eighth step 718, and the ninth step 720 can be considered to be steps that are performed by the appetite engine 610 or with which the appetite engine 610 is involved, and that are encompassed within the execute phase mentioned above. More particularly, at the sixth step, it is determined whether any offers are available. The performing of the sixth step 714 can be considered to correspond to the performing of the eighth step 316 and the additional step 324 of the method 300 of FIG. 3, at which (as discussed above) it is determined by the transaction facilitator computer 101 whether a given borrowing application concerning a given lending option has been approved. Further, if it is determined at the sixth step 714 that a particular offer is available, then the method 700 proceeds to the seventh step 716, at which the loan application is completed, and then to the eighth step 718, at which loan documents are signed, after which the method 700 ends at the end step 720. Alternatively, if at the sixth step 714 it is determined that no offers are available, then no offers are available and the method 700 again ends at the end step 720. By comparison with the method 300 of FIG. 3, it should be appreciated that the seventh step 716 and eighth step 718 together corresponds generally to the combination of the ninth step 318 and the tenth step 320.

Referring particularly to FIG. 8, the fifth method 800 further illustrates in more detail how, during the plan phase of the fifth step (execute appetite engine step) 712, the execute appetite engine 610 evaluates the applicant (or customer) details and calculates an application score for every lender on (or available via) the transaction facilitator company (or transaction facilitator company platform) with which the server computer 600 (and the transaction facilitator computer 101) is associated. The appetite engine 610, when operating to perform the fifth method 800, can be considered to be operating as an “Application Lender Rating System.”

More particularly as shown in FIG. 8, the fifth method 800 begins when information/data regarding an applicant (customer), as represented by a first block 802, and possibly additional information/data regarding a co-applicant (co-customer), as represented by a second block 804, is received for entry into a credit application (e.g., a credit application form) made available by the transaction facilitator computer 101/server computer 600, as represented by a first step 806. Upon receiving the information/data at the transaction facilitator computer 101/server computer 600, then a variety of different weighting factors are applied relative to the received information/data at a second step 808. Subsequently, at a third step 810, the transaction facilitator computer 101/server computer 600 computes a total value based upon the information/data received at the step 806, as modified by application of the weighting factors during the second step 808. After the computation performed at the third step 810 is completed, an overall application lender score is generated at a fourth step 812, which can be utilized by the appetite engine 610 during the build phase and the execute phase as described above.

It should be appreciated further from FIG. 8 that the weighting factors applied at the second step 808 can include any of a variety of different weighting factors depending upon the embodiment, circumstance, or implementation. For example, in the present example embodiment, the weighting factors can include an applicant FICO® v9 weighting factor 814, a co-application (or co-applicant) weighting factor 816, a debt-to-income ratio weighting factor 818, a locale weighting factor 820, an income totals weighting factor 822, and a borrower swap option weighting factor 824. Also, in at least some embodiments, the transaction facilitator computer platform utilizes more than one credit report (e.g., both TransUnion and Experian credit reports) to provide a more accurate assessment of a customer's creditworthiness. This can be valuable because there can be up to a 20-point difference in FICO® scores between two different credit reporting agencies (or bureaus). By utilizing data from two (or more) credit reporting agency sources, the loan decisions made or influenced by the transaction facilitator computer platform are more likely to be based upon comprehensive and reliable information. Additionally, utilization of data from two (or more) credit reporting agency sources can further help to prevent premature rate adjustments and increase the likelihood that loans are allocated to the most suitable applicants at the right time, without (or with reduced likelihood of) potential bias or oversight that can occur with human involvement.

Thus, in accordance with the method 800 of FIG. 8, during the plan (or planning) phase, the transaction facilitator computer 101/server computer 600 (and particularly the appetite engine 610 thereof) assigns a weighted score or value to each application with respect to each lender presenting a lending option. Although not specifically a FICO® credit score, the value assigned to each application by the appetite engine 610 looks at or takes into account the entire application of the customer in the context of a single lender. Based upon the value, the transaction facilitator computer 101/server computer 600 can rapidly determine any given lender's appetite for a given loan opportunity (or for the lending business opportunity presented by a given home improvement project) based on how the application was configured. Further, as underwriting guidelines change, it is possible to dynamically reduce/increase the threshold for each lender to help identify faster approvals.

Therefore, in accordance with the practice of this disclosure, as shown in FIG. 1, FIG. 2, FIG. 3, FIG. 4, FIG. 5, FIG. 6, FIG. 7, and FIG. 8, and as embodied in the claims and discussion regarding example embodiments provided throughout the present disclosure, the present disclosure relates to numerous different methods and systems for achieving (or for facilitating the achieving of) funding for a first home improvement project with respect to a first consumer, or for multiple home improvement projects with respect to that first consumer or multiple consumers. It should be appreciated that the present disclosure encompasses, in addition to the above-described systems, methods, concepts, and features, additional systems, methods, concepts, and features that differ from the above-described systems methods, concepts, and features. For example, the present disclosure includes additional embodiments of systems and methods that include some of, but not all of, the features described above.

Also for example, the present disclosure envisions embodiments in which the selection of lenders can occur based on contractor or customer preferred loan program. Additionally, in at least some embodiments, if a circumstance arises in which a contractor (or dealer) is presented with multiple lending options from multiple lenders, the respective lender terms offered by the respective lenders are different from the standpoint of promotional features (e.g., with one lender offering deferred interest but another lender merely offering standard payment terms), but nevertheless all or more than one of the lending options may be of interest to a consumer in terms of the lender characteristics (e.g., where multiple lenders all handle excellent credit well), then in such circumstance the system can present such multiple lending options to a given consumer rather than a single lending option (and this may occur even though a particular lending option may be preferred by the contractor). Operation of the system in such a context or in accordance with an algorithm allowing for multiple lenders to be considered can be referred to as a “double waterfall” operation.

Further for example, the present disclosure envisions embodiments in which lender and consumer feedback are obtained and utilized to identify more preferred lender program/lender to fit the customer. Additionally the present disclosure envisions embodiments in which the transaction facilitator computer 101 operates to combine loan payment data and credit data and e-check payments data, where this data goes directly to contractor books in a single file—that is, merging of an administrative component and operationally doing the transactions in a manner differing from conventional methodologies. Further, the present disclosure also envisions embodiments in which, when a consumer is issued a credit hold, and the transaction facilitator company can know that and help consumer proceed past (in spite of) the credit hold.

In at least some embodiments encompassed herein, one or more advantages are achieved by the systems or methods associated with those embodiments. It is envisioned that one or more embodiments of systems and methods described or encompassed by the present disclosure can achieve, or facilitate the achieving of, consumer lending in the context of home improvement projects. For example, the present disclosure envisions at least some embodiments in which a soft credit pull is employed to identify or help identify the appropriate or suitable lending options for a customer/borrower/purchaser, or the appropriate or suitable lenders which are likely to loan funds (or from which funds can likely be borrowed), based upon the credit history of the customer/borrower/purchaser.

Each and every document cited in this present application, including any cross referenced or related patent or application, is incorporated in this present application in its entirety by this reference, unless expressly excluded or otherwise limited. The citation of any document is not an admission that it is prior art with respect to any embodiment disclosed in this present application or that it alone, or in any combination with any other reference or references, teaches, suggests, or discloses any such embodiment. Further, to the extent that any meaning or definition of a term in this present application conflicts with any meaning or definition of the same term in a document incorporated by reference, the meaning or definition assigned to that term in this present application governs.

The present invention includes the description, examples, embodiments, and drawings disclosed; but it is not limited to such description, examples, embodiments, or drawings. As briefly described above, the reader should assume that features of one disclosed embodiment can also be applied to all other disclosed embodiments, unless expressly indicated to the contrary. Unless expressly indicated to the contrary, the numerical parameters set forth in the present application are approximations that can vary depending on the desired properties sought to be obtained by a person of ordinary skill in the art without undue experimentation using the teachings disclosed in the present application. Modifications and other embodiments will be apparent to a person of ordinary skill in the applicable arts, and all such modifications and other embodiments are intended and deemed to be within the scope of the present invention.

It is specifically intended that the present invention not be limited to the embodiments and illustrations contained herein, but include modified forms of those embodiments including portions of the embodiments and combinations of elements of different embodiments as come within the scope of the following claims.

What is claimed is:

1. A method for achieving funding for a first home improvement project of interest to a first consumer, the method comprising:
providing at least one first computer (101) including at least one processing device and at least one memory device, wherein the at least one first computer is operated by a transaction facilitation company and is configured to communicate with one or more other computers by at least one internet-based communication link (108);
receiving first information at the at least one first computer (101) from the at least one internet-based communication link (108), the first information concerning at least one lead relating to the first home improvement project of interest to the first consumer;
additionally receiving second information at the at least one first computer (101) from the at least one internet-based communication link, the second information relating to a first soft credit application by the first consumer;
sending third information for receipt by one or more lending company computers including a second computer (102) operated by a first lending company, the third information relating to a soft credit pull report;
further receiving fourth information at the at least one first computer (101) from the at least one internet-based communication link at least indirectly from the one or more lending company computers including the second computer (102), wherein the fourth information includes an indication that the first lending company has approved of the first soft credit application; and
additionally sending, for receipt either by a third computer (103) operated by a first contractor or a fourth computer (104) operated by the first consumer, the fourth information or further information based upon the fourth information,
wherein, based upon the fourth information or the further information, the first consumer is able at least indirectly to complete a loan arrangement so as to fund the first home improvement project.

2. The method of claim 1, wherein the first information is received at least indirectly from one or more of the third computer (103) operated by the first contractor, the fourth computer (104) operated by the first consumer, and a fifth computer (105) operated by a lead generation company.

3. The method of claim 2,
wherein the first information additionally includes an indication of consent from the first consumer that a soft credit pull may be performed in relation to the first consumer, and
wherein the method further comprises additionally sending at least a portion of the first information or the second information for receipt by a sixth computer (106) operated by a credit reporting agency including the indication of consent by the first consumer that the soft credit pull may be performed.

4. The method of claim 3,
wherein the soft credit pull report is received at the at least one first computer (101) from the at least one internet-based communication link (108) at least indirectly from the sixth computer (106) operated by the credit reporting agency computer (106), the soft credit pull report being indicative of at least one credit characteristic of the first consumer; and
wherein the at least one first computer (101) at least partly utilizes the soft credit pull report to classify one or more lending companies respectively associated with the one or more lending company computers and to determine how or when the third information is sent to respective ones of the one or more lending company computers including the second computer (102).

5. The method of claim 4,
wherein the at least one credit characteristic includes a FICO® score and a debt-to-income ratio, and either the further information or additional information includes lending company historical approval levels based on the FICO® score and the debt-to-income ratio; and
wherein the at least one first computer (101) utilizes the further information or additional information to classify one or more lending companies respectively associated with the one or more lending company computers and to determine how or when the third information is sent to respective ones of the one or more lending company computers including the second computer (102).

6. The method of claim 5, wherein the lending company historical approval levels are updated in real time each time another consumer seeks funding for another home improvement project.

7. The method of claim 1,
wherein the further information or additional information at least partly concerns lending companies that will extend loans to customers of the first contractor and are thereby identified as eligible lending companies; and
wherein the at least one first computer (101) utilizes the further information or additional information to classify one or more eligible lending companies respectively associated with the one or more lending company computers and the third information is sent to only the one or more lending company computers with which the one or more eligible lending companies are respectively associated, including the second computer (102).

8. The method of claim 7,
wherein the soft credit pull report is received at the at least one first computer (101) from the at least one internet-based communication link (108) at least indirectly from a sixth computer (106) operated by the credit reporting agency computer (106), the soft credit pull report being indicative of at least one credit characteristic of the first consumer; and
wherein the at least one first computer (101) at least partly utilizes the soft credit pull report to classify one or more lending companies respectively associated with the one or more lending company computers and to determine how or when occurs the sending of the third information to respective ones of the one or more lending company computers including the second computer (102).

9. The method of claim 1, wherein the method further comprises:
based at least partly upon the at least one credit characteristic of the first consumer, performing a classification with respect to lender suitability.

10. The method of claim 9, wherein the classification is performed at least in part by an appetite engine implemented at least partly on a server computer included by the at least one first computer (101).

11. The method of claim 10, wherein the appetite engine accesses one or more of application information, dealer configuration, and lender status information from a least recently used (LRU) cache included as part of the at least one first computer (101).

12. The method of claim 11, wherein the at least one credit characteristic of the first consumer includes one or more of an applicant FICO® value, a co-application FICO® value, a debt-to-income ratio value, a locale value, an income totals value, and a borrower swap option value.

13. The method of claim 9, wherein the method further comprises:
selecting the first lending company from among a plurality of lending companies and sending the third information to respective ones of the one or more lending company computers including the second computer (102), based upon the at least one credit characteristic of the consumer.

14. The method of claim 13, wherein the sending of the third information for receipt by the lending companies of the one or more lending company computers including the second computer (102) occurs in this order of decision making: only eligible lending companies, then based on the soft credit pull report to classify one or more lending companies respectively, and then based upon the at least one credit characteristic of the consumer.

15. The method of claim 1, wherein the at least one first computer (101) is configured to provide or serve as both a lead customer relations management (CRM) service and a lending platform.

16. The method of claim 15, further comprising communicating, between the lending platform of the at least one first computer (101) and the lead CRM service of the at least one computer (101), at least some of the first information, the second information, the third information, the fourth information, or the further information.

17. The method of claim 1, wherein the at least one first computer (101) is configured to communicate with one or both of the third computer (103) operated by the first contractor and the fourth computer (104) operated by the first consumer in a manner that includes one or more of (a) an email communication, (b) a text message communication, or (c) a customer relations management (CRM) application programming interface (API) communication.

18. The method of claim 1,
wherein the first information concerning at least one lead relating to the first home improvement project of interest to the first consumer is obtained from the at least one internet-based communication link (108) at least indirectly from the fourth computer (104) operated by the first consumer, and
wherein the first information includes a loan application and is submitted via a web portal made available by the at least one first computer (101).

19. The method of claim 18,
wherein the first information additionally includes an indication of consent provided by the first consumer that either the loan application can be submitted for consideration or a soft credit pull can be performed in relation to the first consumer, and
wherein the indication of consent is received in response to a text message requesting the indication of consent provided via the web portal.

20. The method of claim 19, wherein the method further comprises:
additionally sending at least a portion of the first information or the second information for receipt by a sixth computer (106) operated by a credit reporting agency including the indication of consent by the first consumer that the soft credit pull may be performed;
further receiving the soft credit pull report, which is indicative of at least one credit characteristic of the first consumer; and
based at least partly upon the soft credit pull report, performing a classification with respect to lender suitability and selecting the first lending company from among a plurality of lending companies.

21. The method of claim 1,
wherein the fourth information received at least indirectly from the second computer (102) operated by the first lending company is communicated by an application programming interface (API), and
wherein the fourth information or further information that is additionally sent by the at least one first computer (101) is sent to the fourth computer (104) operated by the first consumer either in an email form or a text message form, the fourth information or further information being supplemented by loan documentation communicated at least indirectly from the second computer (102) operated by the first lending company.

22. The method of claim 21,
wherein based upon the soft credit pull report, the third information is sent successively to different ones of the plurality of lending company computers including the second computer (102) until the at least one first computer (101) receives the indication that the first lending company has approved of the first soft credit application.

23. The method of claim 1,
wherein the first information obtained at the at least one first computer (101) is received due to an interaction by the first contractor with a lead customer relations management (CRM) application that is accessible at the third computer (103) by the first contractor, as made available by the at least one first computer (101), and
wherein the receiving of the first information occurs in response to a lead generated by a third party campaign in accordance with which a phone call from the first consumer is transferred to the first contractor.

24. The method of claim 1, wherein the at least one first computer (101) is configured to operate so that the loan arrangement is determined in a manner that accounts for each of a creditworthiness of the first consumer, at least one loan characteristic desired by the first consumer, and a plurality of loan options that are available from a plurality of lending companies.

25. The method of claim 24, wherein the at least one first computer (101) is configured to assess the creditworthiness of the first consumer based upon at least two credit reports including each of a first credit report received from a first credit reporting agency and a second credit report received from a second credit reporting agency, wherein the first credit report includes or included by the soft credit pull report.

26. A system for achieving funding for a first home improvement project of interest to a first consumer, the system comprising:
at least one first computer (101) including at least one processing device and at least one memory device, wherein the at least one first computer (101) is operated by a transaction facilitation company,
wherein the at least one first computer (101) is configured to engage in internet-based communications by at least one internet-based communication link (108) with a plurality of other computers, the plurality of other computers including each of (a) one or more second computers (102) respectively operated or controlled by one or more lending companies including a first lending company, respectively, (b) one or more third computers (103) respectively operated or controlled by one or more contractors, respectively, (c) one or more fourth computers (104) respectively operated or controlled by one or more consumers including the first consumer, respectively, (d) one or more fifth computers (105) respectively operated or controlled by one or more lead generators, respectively, and (e) one or more sixth computers (106) respectively operated or controlled by one or more credit reporting agencies, respectively;
wherein the at least one first computer (101) is programmed to operate in accordance with software so that the at least one first computer (101) is configured to:
receive first information concerning at least one lead relating to the first home improvement project of interest to the first consumer;
additionally receive second information relating to a first soft credit application by the first consumer;
based upon a soft credit pull report, send third information for receipt by the one or more second computers (102);
further receive fourth information at least indirectly from the one or more second computers (102), the fourth information includes an indication that the first lending company has approved of the first soft credit application; and
additionally send, for receipt either by the one or more third computers (103) or the one or more fourth computers (104), the fourth information or further information based upon the fourth information, so as to enable the first consumer is able at least indirectly to complete a loan arrangement so as to fund the first home improvement project.

27. The system of claim 26, wherein the at least one first computer (101) is configured to provide or serve as both a lead customer relations management (CRM) service and a lending platform.

28. The system of claim 27, wherein the at least one first computer (101) is configured to allow communicating between the lending platform of the at least one first computer (101) and the lead CRM service of the at least one computer (101).

29. The system of claim 26, wherein the at least one first computer (101) is configured to communicate with the one or more third computers (103) respectively operated or controlled by one or more contractors, respectively, or the one or more fourth computers (104) respectively operated or controlled by the one or more consumers, respectively, in a manner that includes one or more of (a) an email communication, (b) a text message communication, or (c) a customer relations management (CRM) application programming interface (API) communication.

30. The system of claim 26, wherein the at least one first computer (101) at least partly is implemented as part of a cloud computing system (110).

31. The system of claim 26, wherein the at least one first computer (101) includes a server computer (600) having a least recently used (LRU) cache and implementing an appetite engine.

32. The system of claim 26, wherein the at least one first computer (101) is configured to engage, at least indirectly or partly, in wireless communications in relation to the one or more second computers (102), one or more third computers (103), one or more fourth computers (104), one or more fifth computers (105), or one or more sixth computers (106), at least one of which is a mobile device.

33. The method of claim 26, wherein the at least one first computer (101) is configured to assess the creditworthiness of the first consumer based upon at least two credit reports including each of a first credit report received from a first one of the credit reporting agencies and a second credit report received from a second one of the credit reporting agencies.
